(19) United States
(12) Patent Application Publication
(10) Pub. No.: US 2016/0112004 A1
(43) Pub. Date: Apr. 21, 2016

(54) Material for Dissipating Heat From and/or Reducing Heat Signature of Electronic Devices and Clothing

(71) Applicant: LAT Enterprises, Inc., d/b/a MediPak Energy Systems, Raleigh, NC (US)

(72) Inventors: Laura Thiel, Raleigh, NC (US); Carlos Cid, Raleigh, NC (US)

(21) Appl. No.: 14/516,127

(22) Filed: Oct. 16, 2014

(51) Int. Cl. H02S 40/42

(52) U.S. Cl. CPC H02S 40/42

(57) ABSTRACT

A material for dissipating heat from and/or reducing the heat signature of electronic devices and clothing is disclosed. In one example, a heat-dissipating and/or heat signature-reducing layer is sandwiched between two substrates, wherein the substrates may be flexible, rigid, or a combination of both flexible and rigid. Further, examples of the heat-dissipating and/or heat signature-reducing layer include anti-static, anti-radio frequency (RF), anti-electromagnetic interference (EMI), anti-tarnish, and/or anti-corrosion materials.

### TECHNICAL FIELD

The presently disclosed subject matter relates generally to methods of dissipating heat and/or managing heat signatures of objects and more particularly to a material for dissipating heat from and/or reducing the heat signature of electronic devices and/or clothing.

### BACKGROUND

The military uses various types of portable electronic devices, such as portable battery-operated radios. Certain electronic devices may be heat-generating devices. In particular, a malfunctioning device can cause excessive heating. A drawback of heat-generating devices is that the heat may be transferred to the person using or carrying the device, causing uncomfortableness or burns. Another drawback of heat-generating devices is that the heat may be transferred to other devices, causing damage to these devices. Further, in military applications, heat-generating devices may increase the heat signature of military personnel, making them more prone to detection by thermal imaging and therefore more prone to danger.

### SUMMARY

The presently disclosed subject matter provides an article for dissipating heat comprising a heat-dissipating layer; and one or more substrates disposed in close relation to the heat-dissipating layer. In certain aspects, the heat-dissipating layer comprises one or more of a material selected from the group consisting of an anti-static material, an anti-radio frequency material, an anti-electromagnetic interference material, an anti-corrosion material, or an anti-tarnish material. In particular aspects, the heat-dissipating layer comprises copper shielding plastic. In more particular aspects, the heat-dissipating layer comprises a copper impregnated polymer.

In some aspects, one substrate is bonded to the heat-dissipating layer. In other aspects, one substrate is loosely arranged in relation to the heat-dissipating layer. In certain aspects, the article comprises a first substrate and a second substrate, wherein the heat-dissipating layer is sandwiched between the first and second substrate. In particular aspects, the first and second substrates are bonded to the heat-dissipating layer. In other aspects, the first and second substrates are loosely arranged in relation to the heat-dissipating layer. In yet other aspects, the first substrate is bonded to the heat-dissipating layer and the second substrate is loosely arranged in relation to the heat-dissipating layer.

In some aspects, the one or more substrates are flexible, rigid, or a combination thereof. In certain aspects, the one or more substrates comprise a fabric. In other aspects, the one or more substrates comprise one or more of glass, plastic, or metal. In yet other aspects, the one or more substrates comprise multi-layer structures.

In some aspects, the article is configured to fit inside a hand-held radio holder. In other aspects, the article comprises a solar panel assembly sandwiched between the first substrate and the heat-dissipating layer.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1A, FIG. 1B, FIG. 1C, and FIG. 1D illustrate cross-sectional views of examples of structures that include material for dissipating heat from and/or reducing heat signature of electronic devices and/or clothing;

FIG. 2 illustrates a perspective view of a radio holder article into which the heat-dissipating and/or heat signature-reducing material is installed;

FIG. 3 and FIG. 4 illustrate a perspective view and an exploded view, respectively, of a flexible solar panel article into which the heat-dissipating and/or heat signature-reducing material is installed; and

FIG. 5 illustrates a flow diagram of an example of a method of using the presently disclosed material for dissipating heat from and/or reducing the heat signature of electronic devices and/or clothing.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The presently disclosed subject matter provides a material for dissipating heat from and/or reducing the heat signature of electronic devices and/or clothing. Namely, a heat-dissipating and/or heat signature-reducing material can be incorporated into any article, such as electronic devices and clothing. In one example, a heat-dissipating and/or heat signature-reducing layer is sandwiched between two substrates, wherein the substrates may be flexible, rigid, or a combination of both flexible and rigid.

An aspect of the presently disclosed material for dissipating heat from and/or reducing heat signature of electronic devices and/or clothing is that it can be used to protect a person from heat from a heat-generating article or source.

Another aspect of the presently disclosed material for dissipating heat from and/or reducing heat signature of electronic devices and/or clothing is that it can be used to protect an article from any external heat source.

Yet another aspect of the presently disclosed material for dissipating heat from and/or reducing heat signature of electronic devices and/or clothing is that it can be used to reduce the heat signature of a heat-generating article.

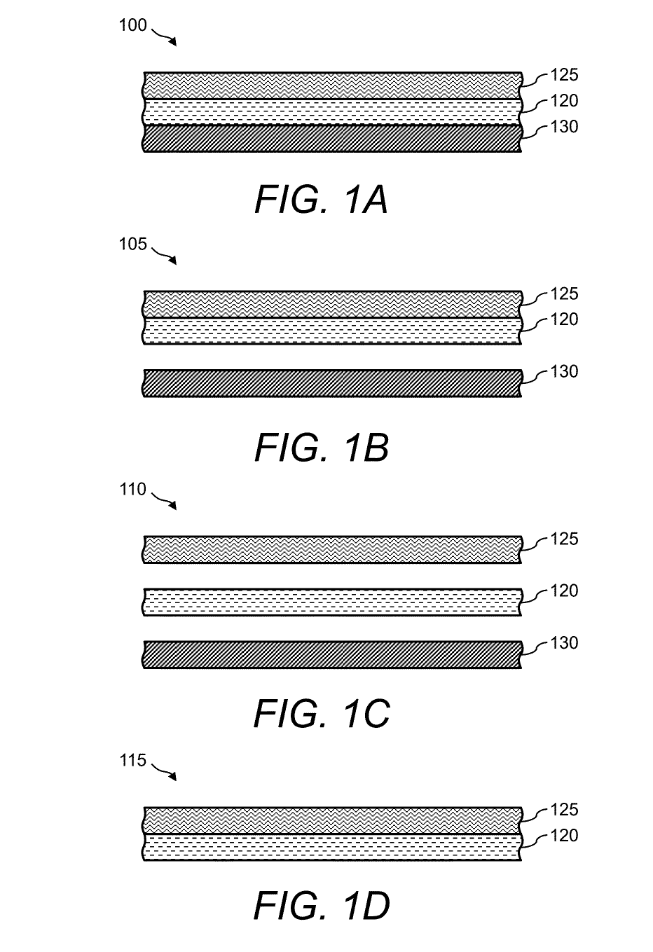

Referring now to FIG. 1A, FIG. 1B, FIG. 1C, and FIG. 1D are cross-sectional views of examples of structures that include the material for dissipating heat from and/or reducing heat signature of electronic devices and/or clothing. The heat-dissipating and/or heat signature-reducing material can be used in combination with, for example, one or two substrates. For example, FIG. 1A shows a structure 100 that includes a heat-dissipating and/or heat signature-reducing layer 120. The heat-dissipating and/or heat signature-reducing layer 120 can be sandwiched between a first substrate 125 and a second substrate 130.

The heat-dissipating and/or heat signature-reducing layer 120 can be any material that is suitable for dissipating heat from and/or reducing the heat signature of electronic devices and/or clothing. The heat-dissipating and/or heat signature-reducing layer 120 can be from about 20 μm thick to about 350 μm thick in one example. In particular embodiments, the heat-dissipating and/or heat signature-reducing layer 120 can have a thickness ranging from about 1 mil to about 6 mil, including 1, 2, 3, 4, 5, and 6 mil, or about 25 μm to about 150 μm, including 25, 50, 75, 100, 125, and 150 μm. Examples of the heat-dissipating and/or heat signature-reducing layer 120 include anti-static, anti-radio frequency (RF), and/or anti-electromagnetic interference (EMI) materials, such as copper shielding plastic or copper particles bonded in a polymer matrix, as well as anti-tarnish and anti-corrosion materials. A specific example of the heat-dissipating and/or heat signature-reducing layer 120 is the anti-static material used in Corrosion Intercept Pouches, catalog number 034-2024-10, available from University Products Inc. (Holyoke, Mass.). Such materials can comprise copper shielded or copper impregnated polymers including, but not limited to, polyethylene, low-density polyethylene, high-density polyethylene, polypropylene, and polystyrene.

The first substrate 125 and the second substrate 130 can be any flexible or rigid substrate material. An example of a flexible substrate is any type of fabric. Examples of rigid substrates include, but are not limited to, glass, plastic, and metal. A rigid substrate may be, for example, the housing of any device. In one example, both the first substrate 125 and the second substrate 130 are flexible substrates. In another example, both the first substrate 125 and the second substrate 130 are rigid substrates. In yet another example, the first substrate 125 is a flexible substrate and the second substrate 130 is a rigid substrate. In still another example, the first substrate 125 is a rigid substrate and the second substrate 130 is a flexible substrate. Further, the first substrate 125 and the second substrate 130 can be single-layer or multi-layer structures.

In structure 100 of FIG. 1A, the heat-dissipating and/or heat signature-reducing layer 120, the first substrate 125, and the second substrate 130 are bonded or otherwise attached together (e.g., by adhesive, stitching, hook-and-loop fastener system). In another example and referring now to FIG. 1B, in a structure 105, the first substrate 125 is bonded to one side of the heat-dissipating and/or heat signature-reducing layer 120, whereas the second substrate 130 is provided loosely against the other side of the heat-dissipating and/or heat signature-reducing layer 120. In yet another example and referring now to FIG. 1C, in a structure 110, the first substrate 125 is provided loosely against one side of the heat-dissipating and/or heat signature-reducing layer 120 and the second substrate 130 is provided loosely against the other side of the heat-dissipating and/or heat signature-reducing layer 120. In still another example and referring now to FIG. 1D, in a structure 115, the heat-dissipating and/or heat signature-reducing layer 120 is provided in combination with the first substrate 125 only, either bonded or loosely arranged. The presently disclosed material is not limited to the structures 100, 105, 110, 115. These structures are exemplary only.

The heat-dissipating and/or heat signature-reducing layer 120 can be used as a protective shield against heated objects and also for reducing the heat signature of objects. For example, in military applications, the heat-dissipating and/or heat signature-reducing layer 120 can be used to reduce the heat signature of devices or clothing for military personnel to reduce the risk of their being detected by thermal imaging.

Other examples of applications and/or uses of the heat-dissipating and/or heat signature-reducing layer 120 include, but are not limited to, insulating battery packs (e.g., in any battery housing or electronic device housing); protecting device and/or users from undesirable external heat; forming sandwich structures; form fitting to a particular device; enclosing electronic materials to prevent corrosion or feathering; medical applications to protect patients from heated devices used in surgical procedures, for example, in robotics (e.g., for use in disposable, sterile drapes); forming solar panels; lining tents (e.g., to prevent heat from going in or out); forming heat shields or guards for mufflers on, for example, motorcycles, lawn mowers, leaf blowers, or weed eaters; lining gloves to protect from flames, handling ice, and/or for preparing food (including pastry preparation).

Other examples of protective flexible heat shielding applications in which the heat-dissipating and/or heat signature-reducing layer 120 can be used include gloves (e.g., fire pit gloves, gloves/forearm shields for operating two-stroke engine yard equipment), integrated in uniforms (e.g., nurses/scrub technicians in operating rooms vs. electro cautery), motorcyclist (clothing) protection from tail pipes, protective shielding in radio pouches (e.g., protecting person from radio heat, protecting radio from heating battery, protecting battery from heating radio, protecting battery from external heat sources), protection on the bottom of a laptop (inside the laptop housing), protection layer from heat of laptop for laps (e.g., lap tray) and expensive furniture (e.g., furniture pad), and portable protective heat shield (e.g., protect sensitive electronics and persons, varies in sizes).

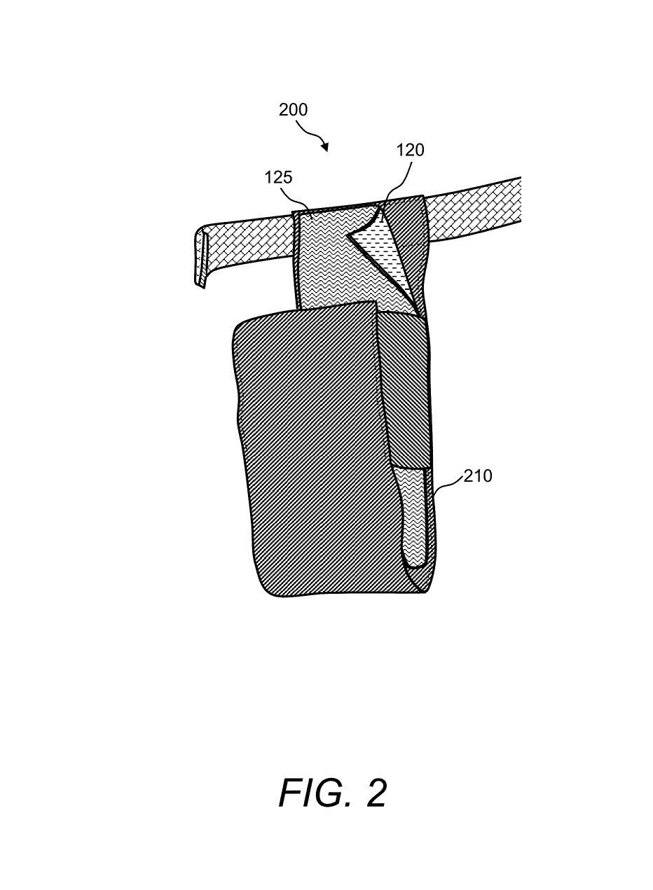

Referring now to FIG. 2 is a perspective view of a radio holder article 200 into which the heat-dissipating and/or heat signature-reducing layer 120 is installed. The radio holder article 200 is an example of equipment that may be used by military personnel. The radio holder article 200 is but one example of using the heat-dissipating and/or heat signature-reducing layer 120 for dissipating heat from and/or reducing the heat signature of an article.

In this example, the radio holder article 200 is a radio holder that can be worn on the user's belt. Namely, a radio (not shown) can be held in a pouch 210 of the radio holder article 200. In this example, a structure, such as the structure 115 of FIG. 1D, is formed separately and then inserted into the pouch 210 of the radio holder article 200. In another example, in the case of the structure 105 of FIG. 1B, the radio holder article 200 itself serves as the second substrate 130.

In this example, the heat-dissipating and/or heat signature-reducing layer 120 protects the user from heat from the radio (not shown), the heat-dissipating and/or heat signature-reducing layer 120 protects the radio (not shown) from any external heat source (not shown), and the heat-dissipating and/or heat signature-reducing layer 120 reduces the heat signature of the radio (not shown).

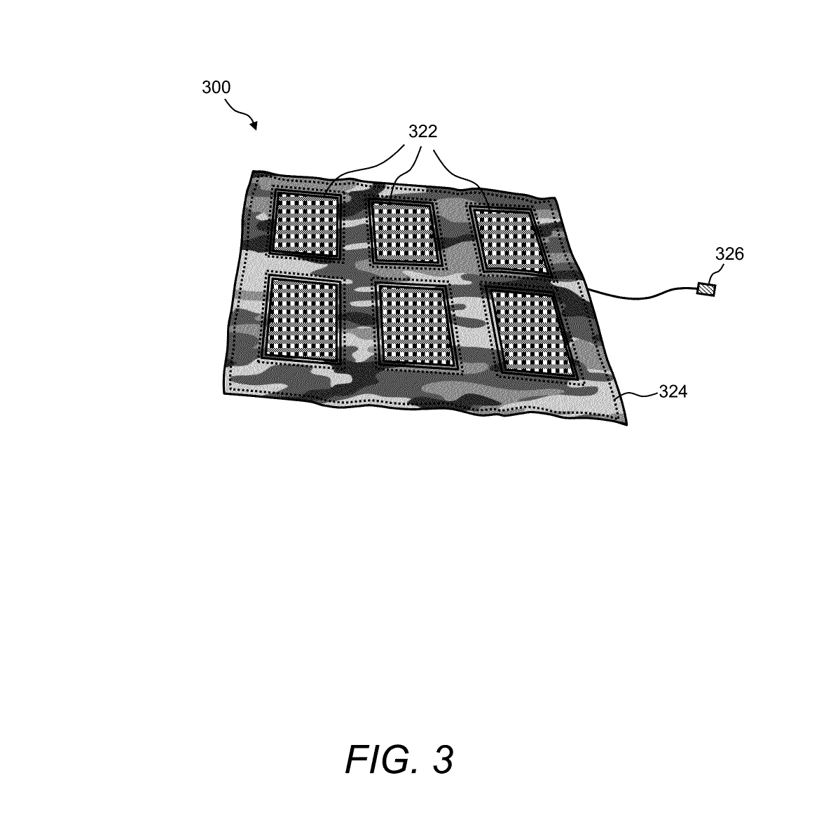

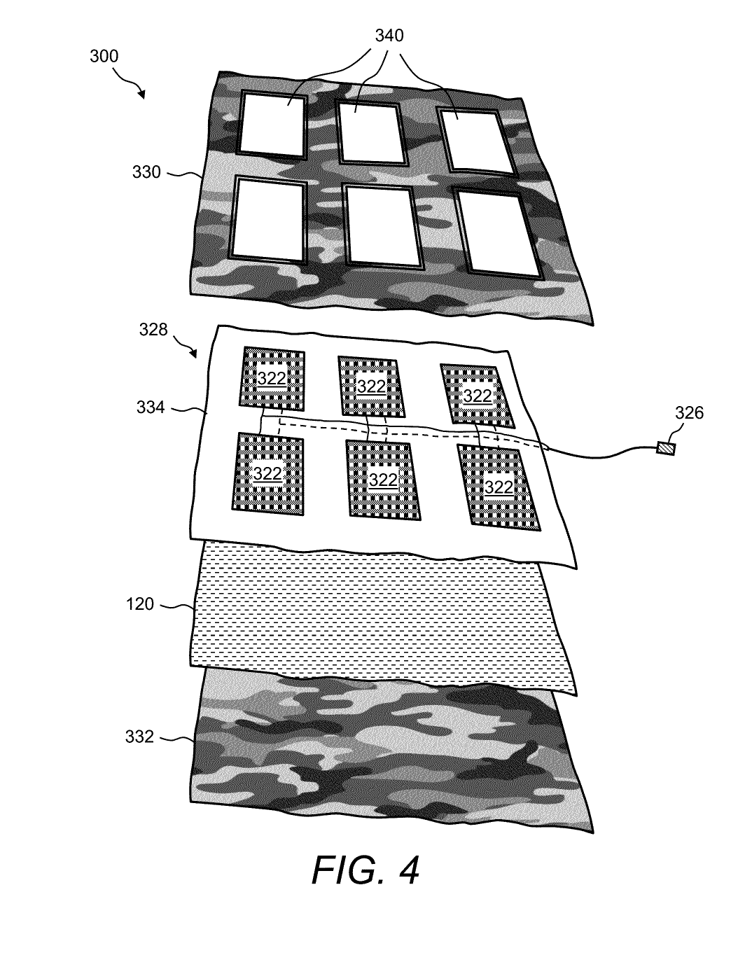

Referring now to FIG. 3 and FIG. 4 is a perspective view and an exploded view, respectively, of a flexible solar panel article 300 into which the heat-dissipating and/or heat signature-reducing layer 120 is installed. The flexible solar panel article 300 is another example of equipment that may be used by military personnel. The flexible solar panel article 300 is but another example of using the heat-dissipating and/or heat signature-reducing layer 120 for dissipating heat from and/or reducing the heat signature of an article.

In this example, the flexible solar panel article 300 is a flexible solar panel that can be folded up and carried in a backpack and then unfolded and deployed as needed. The flexible solar panel article 300 is used, for example, to charge rechargeable batteries or to power electronic equipment directly.

The flexible solar panel article 300 is a multilayer structure that includes multiple solar modules 322 mounted on a flexible substrate, wherein the flexible substrate with the multiple solar modules 322 is sandwiched between two layers of fabric. Windows are formed in at least one of the two layers of fabric for exposing the solar modules 322.

A hem 324 may be provided around the perimeter of the flexible solar panel article 300. In one example, the flexible solar panel article 300 is about 36 x 36 inches. The output of any arrangement of solar modules 322 in the flexible solar panel article 300 is a direct current (DC) voltage. Accordingly, the flexible solar panel article 300 includes an output connector 326 that is wired to the arrangement of solar modules 322. The output connector 326 is used for connecting any type of DC load to the flexible solar panel article 300. In one example, the flexible solar panel article 300 is used for supplying power a device, such as a DC-powered radio. In another example, the flexible solar panel article 300 is used for charging a battery.

The flexible solar panel article 300 includes a solar panel assembly 328 that is sandwiched between a first fabric layer 330 and a second fabric layer 332. The first fabric layer 330 and the second fabric layer 332 can be formed of any flexible, durable, and substantially waterproof or at least water resistant material, such as but not limited to, polyester, PVC-coated polyester, vinyl-coated polyester, nylon, canvas, PVC-coated canvas, and polycotton canvas. The first fabric layer 330 and the second fabric layer 332 can be any color or pattern, such as the camouflage pattern shown in FIG. 3 and FIG. 4.

The solar panel assembly 328 of the flexible solar panel article 300 includes the multiple solar modules 322 mounted on a flexible substrate 334. A set of windows or openings 340 is provided in the first fabric layer 330 for exposing the faces of the solar modules 322. The flexible substrate 334 is formed of a material that is lightweight, flexible (i.e., foldable or rollable), printable, and substantially waterproof or at least water resistant.

In the flexible solar panel article 300, the heat-dissipating and/or heat signature-reducing layer 120 is incorporated into the layers of fabric that form the flexible solar panel article 300, in similar fashion to the structure 100 of FIG. 1A. Namely, the heat-dissipating and/or heat signature-reducing layer 120 is provided at the back of solar modules 322, between the flexible substrate 334 and the second fabric layer 332. In this example, the first fabric layer 330, the flexible substrate 334, the heat-dissipating and/or heat signature-reducing layer 120, and the second fabric layer 332 are held together by stitching and/or by a hook-and-loop fastener system.

In this example, the heat-dissipating and/or heat signature-reducing layer 120 protects the user from heat from the back of the flexible solar panel article 300, the heat-dissipating and/or heat signature-reducing layer 120 protects the back of the flexible solar panel article 300 from any external heat source (not shown), and the heat-dissipating and/or heat signature-reducing layer 120 reduces the heat signature of the flexible solar panel article 300.

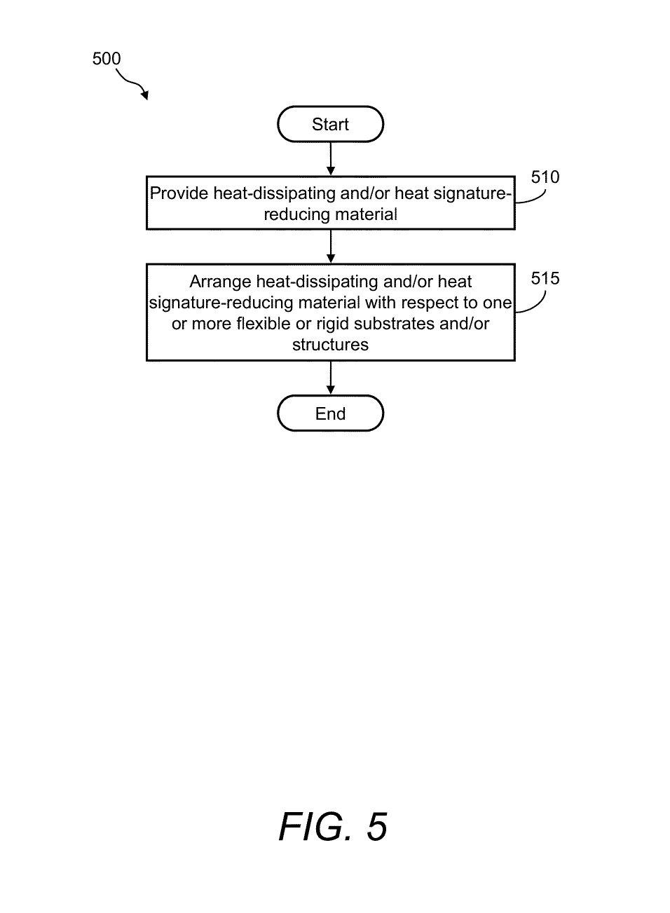

Referring now to FIG. 5 is a flow diagram of an example of a method 500 of using the presently disclosed material for dissipating heat from and/or reducing heat signature of electronic devices and/or clothing. The method 500 includes, but is not limited to, the following steps.

At a step 510, the heat-dissipating and/or heat signature-reducing layer 120 is provided. In one example, a layer of the anti-static material used in Corrosion Intercept Pouches, catalog number 034-2024-10, available from University Products Inc. (Holyoke, Mass.) is provided.

At a step 515, the heat-dissipating and/or heat signature-reducing layer 120 is arranged with respect to one or more flexible or rigid substrates and/or structures. In one example, the heat-dissipating and/or heat signature-reducing layer 120 is arranged with respect to the first substrate 125 and/or the second substrate 130; examples of which are shown in FIG. 1A, FIG. 1B, FIG. 1C, FIG. 1D, FIG. 2, FIG. 3, and FIG. 4.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. An article for dissipating heat comprising:
a. a heat-dissipating layer; and
b. one or more substrates disposed in close relation to the heat-dissipating layer.

2. The article of claim 1 wherein the heat-dissipating layer comprises one or more of a material selected from the group consisting of an anti-static material, an anti-radio frequency material, an anti-electromagnetic interference material, an anti-corrosion material, or an anti-tarnish material.

3. The article of claim 2 wherein the heat-dissipating layer comprises a copper shielding plastic.

4. The article of claim 2 wherein the heat-dissipating layer comprises a copper impregnated polymer.

5. The article of claim 1 comprising one substrate bonded to the heat-dissipating layer.

6. The article of claim 1 comprising one substrate loosely arranged in relation to the heat-dissipating layer.

7. The article of claim 1 comprising a first substrate and a second substrate, wherein the heat-dissipating layer is sandwiched between the first and second substrate.

8. The article of claim 7 wherein the first and second substrates are bonded to the heat-dissipating layer.

9. The article of claim 7 wherein the first and second substrates are loosely arranged in relation to the heat-dissipating layer.

10. The article of claim 7 wherein the first substrate is bonded to the heat-dissipating layer and the second substrate is loosely arranged in relation to the heat-dissipating layer.

11. The article of claim 1 wherein the one or more substrates are flexible, rigid, or a combination thereof.

12. The article of claim 1 wherein the one or more substrates comprise a fabric.

13. The article of claim 1 wherein the one or more substrates comprise one or more of a material selected from the group consisting of a glass, a plastic, and a metal.

14. The article of claim 1 wherein the one or more substrates comprise multi-layer structures.

15. The article of claim 2 wherein the article is configured to fit inside a hand-held radio holder.

16. The article of claim 7 further comprising a solar panel assembly sandwiched between the first substrate and the heat-dissipating layer.

17. The article of claim 16 wherein the solar panel assembly comprises multiple solar panels.

18. The article of claim 16 wherein the first substrate comprises cut-outs configured to expose the solar panel assembly.

19. The article of claim 16 further comprising an output connector electrically coupled to the solar panel assembly.

20. The article of claim 16 wherein the article is foldable.
